(19) United States
(12) Patent Application Publication
(10) Pub. No.: US 2023/0029297 A1
(43) Pub. Date: Jan. 26, 2023

(54) Ventilation Device For A Vehicle Cabin

(71) Applicants: Gentherm GmbH, Odelzhausen (DE); BAYERISCHE MOTOREN WERKE AKTIENGESELLSCHAFT, München (DE)

(72) Inventors: Dan Botez, Augsburg (DE); Thomas Johansen, Kirchseeon (DE); Christian Rosskopf, Donauworth (DE); Thomas Rotenburg, Pullach (DE); Stefan Wiedemann, München (DE)

(21) Appl. No.: 17/785,980

(22) PCT Filed: Dec. 15, 2020
(86) PCT No.: PCT/DE2020/000336

§ 371 Date: Jun. 16, 2022

(30) Foreign Application Priority Data
Dec. 20, 2019 (DE) 102019008905.7
Apr. 24, 2020 (DE) 102020002485.8

(51) Int. Cl. B60H 1/00; B60H 1/24; B60H 1/32

(52) U.S. Cl. CPC B60H 1/00207; B60H 1/244; B60H 1/32281; B60H 2001/00235; B60H 2001/002

(57) ABSTRACT

A ventilation device for a cabin of a vehicle, the ventilation device includes a temperature-control circuit in which a fluid circulates for heat transfer; an ambient heat exchanger via which heat is exchanged between the temperature-control circuit and a cabin environment; a cabin heat exchanger via which heat is exchanged between the temperature-control circuit and an air flow provided for ventilating the cabin; one or more liquid channels connecting the ambient heat exchanger to the cabin heat exchanger; an air supply system for directing air to the cabin heat exchanger to supply the passengers in the cabin, and an air conveyor device for conveying supply air; and a distance between the air conveyor device and the passenger is greater than a distance between the cabin heat exchanger and the passenger.

### CROSS-REFERENCE TO RELATED APPLICATIONS

This application is a US National Stage entry of PCT/DE2020/000336 filed on Dec. 15, 2020, which claims priority to DE 10 2019 008 905.7 filed on Dec. 20, 2019 and to DE 10 2020 002 485.8 filed on Apr. 24, 2020.

### FIELD

The present invention relates to a ventilation device for a cabin of a vehicle and to a vehicle.

### BACKGROUND

It is known to ventilate vehicles through air vents on a roof liner. The cooling of air for vehicle cabins is also known.

In practice, direct temperature control of the air flow, for example via an electrical heating device, is often selected for temperature control of air flows which are to be introduced into the cabin of a vehicle. However, due to the requirement for a separate heating device, this comes with an increase in manufacturing costs. Furthermore, corresponding electric heating devices require a comparatively large amount of energy.

To be able to use existing warm air streams in the vehicle or the ambient air to control the temperature of the air flow to be introduced into the cabin, cabin heat exchangers are used, via which the air flow to be introduced into the cabin is pre-tempered by means of a temperature-control air stream. In this respect, there is the problem in that the air conveyor device, via which the air flow to be introduced into the cabin is generated, impairs the occupant's comfort in the cabin of the vehicle due to vibrations and operating noise. In addition, due to the limited capacity to absorb thermal energy, the temperature-control air flow allows only slow temperature adjustments of the air flow to be introduced into the cabin.

### SUMMARY

The object of the invention is to increase the comfort of the occupant during the temperature control of vehicle cabins.

The object is solved by a ventilation device of the type mentioned above, wherein the distance of the air conveyor device from the passenger is greater than the distance of the cabin heat exchanger from the passenger.

A fluid circulates in the temperature-control circuit as a heat transfer medium.

The ventilation device may have one or more ambient heat exchangers through which heat can be exchanged between the temperature-control circuit and a cabin environment. Preferably, the temperature-control circuit is a closed system. Preferably, a pump is provided in the temperature-control circuit to pump the fluid forward in the circuit and cause circulation of the fluid in the temperature-control circuit.

The ventilation device is preferably configured to operate in a heating mode and/or in a cooling mode. When in heating mode, the supply air is heated before being discharged into the vehicle cabin. When in cooling mode, the supply air is cooled before being discharged into the vehicle cabin. Preferably, the ventilation device is configured to heat or cool the supply air by means of the temperature-control circuit as needed.

In a preferred embodiment of the ventilation device according to the invention, the air conveyor device is arranged in the trunk or in the rear of the vehicle. This effectively avoids the disturbance of passengers by the operation of the air conveyor device. Passenger comfort is not affected by vibrations or noise of the air conveyor device.

In a further embodiment of the ventilation device according to the invention, the air conveyor device is configured as a radial ventilator.

Furthermore, a ventilation device according to the invention is preferred, in which at least one liquid channel has a wall formed from an elastic tube. Preferably, the wall is formed from an elastic tube over at least 80% of the length of the liquid channel. The one or the plurality of liquid channels are preferably thermally insulated from their environment. For example, the one or the plurality of liquid channels has or have a jacket made of an insulating material.

In a further development of the ventilation device according to the invention, at least one liquid channel has, at least in sections, an open cross-section of less than 3 square centimeters, preferably of less than 1.5 square centimeters. This cross-section preferably extends over at least 60% of the channel length of the liquid channel.

The ventilation device according to the invention is advantageously further developed in that the fluid circulating in the temperature-control circuit is a liquid. Because the fluid is a liquid, a comparatively large amount of heat can be introduced into the supply air and removed or discharged from the supply air on the liquid side of the cabin heat exchanger. During heating operation, the temperature of the liquid before entering the heat exchanger is preferably more than 60 degrees Celsius, preferably more than 80 degrees Celsius. During cooling operation, the temperature of the liquid before entering the heat exchanger is preferably less than 20 degrees Celsius, preferably less than 10 degrees Celsius. Preferably, the fluid is liquid in any operating state. Preferably, there is no evaporation. The operating temperature of the fluid is therefore below its boiling point at normal pressure. The fluid preferably has a specific heat capacity that is at least 50% of the specific heat capacity of water. Preferably, the fluid consists of at least 90% water. Preferably, it contains antifreeze as an admixture.

A ventilation device according to the invention is also advantageous in which the ambient heat exchanger is an air-liquid heat exchanger or an evaporator. An air-flow cooler or a cooling aggregate, which works with compressed air or evaporation, is preferably provided at the ambient heat exchanger, via which the temperature-control circuit can be cooled in summer.

In another preferred embodiment of the ventilation device according to the invention, a further ambient heat exchanger of the ventilation device is a liquid-liquid heat exchanger. An inlet and outlet of an engine cooling circuit is preferably provided at this ambient heat exchanger, via which the temperature-control circuit can be supplied with heat in winter.

If the available installation space is small, the functions of the first and second ambient heat exchangers can also be performed by a single heat exchanger.

In a further development, the ventilation device according to the invention has an outflow device via which the supply air tempered in the cabin heat exchanger is supplied to a passenger, wherein the outflow device has at least one outflow opening for allowing air to flow out to a passenger. Preferably, the outflow device comprises at least one air guiding device which guides the outflowing air.

In another advantageous embodiment of the ventilation device according to the invention, the air guiding device has a corrugated Coanda profile to guide exiting air along a cabin wall. The outflow device is preferably operable in at least two different operating states, wherein the outflowing air is preferably subjected to the influence of the Coanda profile to an extent which differs from one another in the two operating states.

A ventilation device according to the invention may further comprise a plurality of outflow devices, wherein preferably at least one individual outflow device is assigned to and arranged in proximity to each passenger. The outflow opening is preferably round or rectangular in shape. The shape of the outflow opening is preferably adapted to the geometry of the air guiding device so that the interaction is improved.

In a further development of the ventilation device according to the invention, the outflow device and/or its outflow opening is arranged above the passenger's head height and/or to the side of the passenger's head. Preferably, the outflow device and/or its outflow opening extends along the centerline of the vehicle or cabin. Alternatively, the outflow opening is arranged close to the centerline of the vehicle.

Preferably, the outflowing air is directed to the passenger or the window assigned to the passenger in at least one operating state of the outflow device. This makes it possible to optimally supply an individual passenger without affecting neighboring passengers. Preferably, at least one air guiding device is assigned to the outflow opening.

In another embodiment of the ventilation device according to the invention, the outflow device is configured to uniformly redirect air exiting the outflow opening in one direction and/or to more uniformly align air exiting the outflow opening in one direction to prevent turbulence.

The ventilation device according to the invention is advantageously further developed in that a first air guiding device has an outlet nozzle which extends the outflow opening in a channel-like manner. The outlet nozzle preferably has a rectangular cross-section. The channel-like extension of the outflow opening provides a uniformly aligned airflow.

In a further development of the ventilation device according to the invention, a second air guiding device has a corrugated Coanda profile which is configured to deflect an air flow emerging from the outflow opening from its original outflow direction by utilizing the Coanda effect. The air flow can thus spread along one wall of the cabin. Preferably, this results in a circulating cabin flow. This circulation preferably creates air circulation around the passenger. Preferably, the axis of rotation of the circulation lies along the longitudinal axis of the vehicle.

Preferably, at least two operating states can be configured at the outflow device, in which operating states the air flowing out of the outflow opening is subject to the influence of at least one of the two air guiding devices to different degrees. For example, the air guiding devices comprising the Coanda profile may have a comparatively large influence on the air flowing out of the outflow opening in a first operating state of the outflow device and a comparatively small influence on the air flowing out of the outflow opening in a second operating state of the outflow device.

In another preferred embodiment of the ventilation device according to the invention, in one operating state of the outflow device, the air flowing out of the outflow opening is removed from the influence of the Coanda profile. Thus, in this operating state, there is no deflection of the airflow exiting the outflow opening by the Coanda profile.

Furthermore, a ventilation device according to the invention is advantageous in which, in an operating state of the outflow device, the Coanda profile acts effectively on the air flowing out of the outflow opening. In this operating state, the airflow exiting the outflow opening is thus deflected by the Coanda profile, wherein the Coanda effect is utilized for the deflection of the airflow. The change between the operating state, in which the air flowing out of the outflow opening is removed from the influence of the Coanda profile, and the operating state, in which the Coanda profile effectively acts on the air flowing out of the outflow opening, is effected by at least one movement or adjustment of at least one air guiding device.

In a further preferred embodiment of the ventilation device according to the invention, the outflow opening has a clear cross-section which has different sizes in at least two operating states of the outflow device. This makes it possible to achieve a change in the velocity of the outflowing air while maintaining the same air velocity and volume flow. Preferably, different amounts of air escape through the outflow opening in two different operating states of the outflow device. The change between the operating states is made by at least one regulation movement.

In a further development of the ventilation device according to the invention, a change of the operating state of the outflow device can be brought about by moving, in particular pivoting, an air guiding device. To bring about a change in the operating state of the outflow device, an adjustment movement is preferably to be carried out on at least one air guiding device. Preferably, the adjustment movement takes place simultaneously with the regulating movement, via which the speed of the air flow exiting the outflow opening or its air volume can be adjusted. This could be done by shifting or pivoting the participating components relative to each other.

A ventilation device according to the invention is further preferred, in which the outflow device has a coupling section assigned to the air supply system, into which the supply air enters on its path along the air supply system, wherein the coupling section is pivotable relative to the air supply system. The coupling section is elongated and has a mostly round cross-section. On the side of this coupling section, an outlet nozzle is provided. The outlet nozzle has a rectangular contour, with its elongated side aligned along the vehicle and a supply nozzle. The coupling area can preferably be pivoted around an axis within a certain angular range. This axis preferably runs essentially along the centerline of the vehicle.

In a particularly preferred embodiment of the ventilation device according to the invention, the outlet nozzle is directed towards the passenger in one operating state of the outlet device and is pivoted away from the passenger in another operating state of the outlet device. In the operating state in which the outflow opening is pivoted away from the passenger, air preferably exits the outflow opening along a vehicle wall or along the Coanda profile and/or the outflow opening is directly adjacent to or aligned with the Coanda profile.

Furthermore, a ventilation device according to the invention is advantageous in which a part of the outflow opening at the outlet nozzle is covered by a cover in one operating state of the outflow device, which part is not covered by the cover in another operating state of the outflow device. When the Coanda profile is pivoted, part of the outflow opening at the outlet nozzle is preferably covered by a cover at the same time. As a result, the Coanda profile is centered on the original outflow opening and on the edge side with regard to the opening thus remaining. The cover can be a movable part on the outlet nozzle. Preferably, the cover is a protrusion assigned to the Coanda profile.

The object of the invention is further solved by a vehicle of the type mentioned at the outset, wherein the ventilation device of the vehicle according to the invention is designed according to one of the embodiments described above. With respect to the advantages and modifications of the vehicle according to the invention, reference is made to the advantages and modifications of the ventilation device according to the invention.

### BRIEF DESCRIPTION OF THE DRAWINGS

In the following, preferred embodiments of the invention are explained and described in more detail with reference to the accompanying drawing. The figure shows:

FIG. 1 is a schematic view of a vehicle according to the invention with fluid lines for temperature-controlled ventilation of a vehicle cabin;

### DETAILED DESCRIPTION

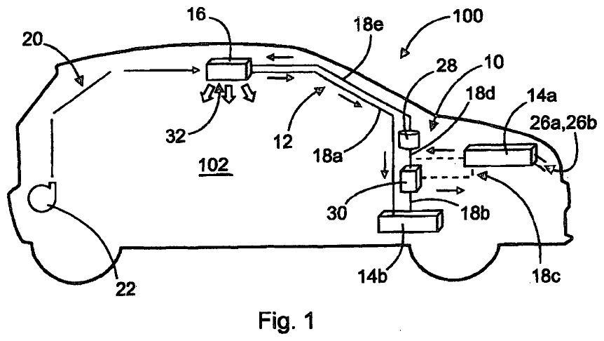

FIG. 1 shows a vehicle 100 with a ventilation device 10 for the cabin 102 of the vehicle 100.

The ventilation device 10 comprises a temperature-control circuit 12 in which a fluid circulates for heat transfer, and an ambient heat exchanger 14b through which heat is exchanged between the temperature-control circuit 12 and a cabin environment. Furthermore, the ventilation device 10 comprises a cabin heat exchanger 16 via which heat is exchanged between the temperature-control circuit 12 and an airflow provided for ventilating the cabin 102, and a plurality of liquid passages 18a-18e connecting the ambient heat exchanger 14b to the cabin heat exchanger 16 to allow circulation of liquid between the ambient heat exchanger 14b and the cabin heat exchanger 16.

In addition, the ventilation device 10 comprises an air supply system 20 for delivering supply air thereover to the cabin heat exchanger 16 for supply to passengers in the cabin 102, and an air conveyor device 22 for conveying supply air from a position at a distance from a passenger to the cabin heat exchanger 16 and then to the passenger.

The temperature-control circuit 12 is a closed system. The liquid channels 18a-18e each have walls formed from elastic tubes over at least 80% of their length. The liquid channels 18a-18e are furthermore thermally isolated from the environment. The open cross-section of the liquid channels 18a-18e is less than 3 square centimeters over at least 60% of their channel length.

A fluid circulates in the temperature-control circuit 12 as a heat transfer medium. The fluid is liquid in any operating state. There is no evaporation. The operating temperature of the fluid is therefore below its boiling point at normal pressure. The fluid has a specific heat capacity that is at least 50% of the specific heat capacity of water. The fluid consists of at least 90% water and contains antifreeze as an admixture.

At the heat exchanger 14a, which can be connected to the temperature-control circuit 12 via the valve 30, inlets and outlets 26a, 26b of an engine cooling circuit are provided, via which the temperature-control circuit 12 can be supplied with heat in winter. The heat exchanger 14a is thus a liquid-liquid heat exchanger.

An air-flow cooler or a cooling aggregate, which works with compressed air or evaporation, is provided at the ambient heat exchanger 14b, via which the temperature-control circuit 12 can be cooled in summer. The ambient heat exchanger 14b is thus an air-liquid heat exchanger or an evaporator.

If the available installation space is small, the functions of the ambient heat exchangers 14a, 14b can also be performed by a single heat exchanger.

Additionally, a pump 28 is provided in the temperature-control circuit 12 to pump the fluid forward in the temperature-control circuit 12. At the liquid side of the cabin heat exchanger 16, a large amount of heat can be transferred to or absorbed by the airflow to be introduced into the cabin 102 via the liquid temperature control fluid. During heating operation, the temperature of the liquid before entering the heat exchanger 16 is more than 60 degrees Celsius, preferably more than 80 degrees Celsius. During cooling operation, the temperature of the liquid before entering the heat exchanger 16 is less than 20 degrees Celsius, preferably less than 10 degrees Celsius.

The supply air to be introduced into the cabin 102 is heated or cooled as required by the temperature-control circuit 12. The supply air is taken from a location at a distance from the passengers, in this case the trunk. This is done by means of a radial ventilator, which is also arranged at a distance from the passengers in the trunk to avoid disturbing the passengers with vibrations and noise.

The supply air to be introduced into the cabin 102 is supplied through a supply channel of the air supply system 20 to the cabin heat exchanger 16, where it is temperature controlled and then supplied to a passenger via an outflow device.

This outflow device is positioned above the passengers' head height and to the side of the passengers' heads, namely along the centerline of the vehicle 100 or cabin 102.

Each passenger may also be assigned an individual outflow device, which is arranged in proximity to the respective passenger.

### REFERENCE NUMBERS

10 ventilation device
12 temperature-control circuit
14a, 14b ambient heat exchanger
16 cabin heat exchanger
18a-18e liquid channels
20 air supply system
22 air conveyor device
26a, 26b inlet and outlet
28 pump
30 valve
32 outflow device
34 inflow device
36 outflow opening
38a, 38b air-guiding devices
100 vehicle
102 cabin

1. A ventilation device of a vehicle, the ventilation device comprising
a temperature-control circuit in which a fluid circulates for heat transport;
an ambient heat exchanger, via which heat is exchanged between the temperature-control circuit and a cabin environment of the cabin;
a cabin heat exchanger, via which the heat is exchanged between the temperature-control circuit and an air flow provided for ventilating the cabin;
one or more liquid channels connecting the ambient heat exchanger to the cabin heat exchanger to allow circulation of liquid between the ambient heat exchanger and the cabin heat exchanger;
an air supply system for supplying the air flow to the cabin heat exchanger; and
an air conveyor device to convey the air flow to the cabin heat exchanger;
wherein a distance between the air conveyor device and a passenger in the cabin is greater than a distance between the cabin heat exchanger and the passenger.

2. The ventilation device according to claim 1, wherein the air conveyor device is arranged in a trunk or in a rear of the vehicle.

3. The ventilation device according to claim 1, wherein the air conveyor device is radial ventilator.

4. The ventilation device according to claim 1, wherein one or more of the one or more liquid channels
has a wall formed from an elastic tube.

5. The ventilation device according to claim 1, wherein the one or more liquid channels
has, at least in sections, an open cross-section of less than 3 square centimeters, or less than 1.5 square centimeters.

6. The ventilation device according to claim 1, wherein
the fluid circulating in the temperature-control circuit is a liquid.

7. The ventilation device according to claim 1, wherein
the ambient heat exchanger is an air-liquid heat exchanger or an evaporator.

8. The ventilation device according to claim 1, wherein
characterized in that a further ambient heat exchanger of the ventilation device is a liquid-liquid heat exchanger.

9. A vehicle comprising
a cabin; and
the ventilation device according to claim 1.

10. The ventilation device according to claim 1, wherein the temperature-control circuit is a closed circuit.

11. The ventilation device according to claim 10, wherein the fluid is liquid and does not evaporate, and has a specific heat capacity that is at least 50% of the specific heat capacity of water.

12. The ventilation device according to claim 11, wherein the fluid consists of at least 90% water and contains antifreeze as a mixture.

13. The ventilation device according to claim 1, wherein the heat exchanger is connected to the temperature-control circuit via a valve, and an inlet an outlet of an engine cooling circuit are provided, via which the temperature-control circuit is supplied with heat, and wherein the heat exchanger is a liquid-liquid heat exchanger.

14. The ventilation device according to claim 13, wherein air-flow cooler or a cooling aggregate is provided at the ambient heat exchanger, via which the temperature-control circuit is cooled, and wherein the ambient heat exchanger is an air-liquid heat exchanger or an evaporator.

15. The ventilation device according to claim 14, wherein the temperature-control circuit comprises a pump to pump the fluid forward in the temperature-control circuit, wherein at a liquid side of the cabin heat exchanger, the heat is transferred to or absorbed by the air flow introduced into the cabin.

16. The ventilation device according to claim 15, wherein an outflow device is positioned above a head and to the side of a head of the passenger, along a centerline of the vehicle or the cabin.
